(19) United States
(12) Patent Application Publication
(10) Pub. No.: US 2019/0137710 A1
(43) Pub. Date: May 9, 2019

(54) HYBRID UNIVERSAL SERIAL BUS INTERCONNECT FOR MICRO FORM-FACTOR PHOTONICS

(71) Applicant: Lattice Semiconductor Corporation, Portland, OR (US)

(72) Inventors: Kihong Kim, San Jose, CA (US); Gyudong Kim, San Jose, CA (US); Chandlee Harrell, San Jose, CA (US)

(21) Appl. No.: 16/221,428

(22) Filed: Dec. 14, 2018

Related U.S. Application Data
(63) Continuation of application No. PCT/US2017/037565, filed on Jun. 14, 2017.
Application No. PCT/US2017/037565 is a continuation-in-part of application No. 15/488,291, filed on Apr. 14, 2017.
Application No. 15/488,291 is a continuation-in-part of application No. PCT/US2017/037561, filed on Jun. 14, 2017.
Application No. PCT/US2017/037565 is a continuation-in-part of application No. 15/488,291, filed on Apr. 14, 2017.
Application No. 15/488,291 is a continuation-in-part of application No. 15/682,478, filed on Aug. 21, 2017.
Application No. 15/682,478 is a continuation-in-part of application No. 15/488,291, filed on Apr. 14, 2017.
Application No. 15/488,291 is a continuation-in-part of application No. 15/488,291, filed on Apr. 14, 2017.
(60) Provisional application No. 62/350,811, filed on Jun. 16, 2016.
(60) Provisional application No. 62/349,836, filed on Jun. 14, 2016.
(60) Provisional application No. 62/377,840, filed on Aug. 22, 2016.
(60) Provisional application No. 62/323,140, filed on Apr. 15, 2016.
(60) Provisional application No. 62/323,140, filed on Apr. 15, 2016.

(51) Int. Cl. G02B 6/42; G02B 6/38; G02B 6/32; H01R 24/60; H01R 13/6461; H01R 13/631

(52) U.S. Cl. CPC G02B 6/4284; G02B 6/3809; H01R 13/6315; H01R 24/60; H01R 13/6461; G02B 6/322

(57) ABSTRACT

Various techniques are provided for implementing a hybrid electrical-optical interface. In one example, the hybrid electrical-optical interface includes a connector body configured to mate with an universal serial bus (USB) component in accordance with a predetermined mechanical misalignment tolerance, a plurality of electrical conduits disposed within the connector body and configured to pass electrical signals, and an optical conduit disposed within the connector body between at least two of the electrical conduits, wherein the optical conduit is configured to pass optical signals through a free space gap formed while the connector body is mated with the USB component, and configured to maintain communication of the optical signals through the free space gap while the connector body and the USB component are within the misalignment tolerance. Additional implementations and related methods are also provided.

### CROSS-REFERENCE TO RELATED APPLICATIONS

This application is a continuation of International Application No. PCT/US2017/037565 filed Jun. 14, 2017, which is incorporated by reference herein in its entirety.

International Application No. PCT/US2017/037565 claims the benefit of U.S. Provisional Patent Application No. 62/350,811, filed Jun. 16, 2016, which is incorporated by reference herein in its entirety.

International Application No. PCT/US2017/037565 is a continuation-in-part of U.S. patent application Ser. No. 15/488,291, filed Apr. 14, 2017, which is incorporated by reference herein in its entirety.

This application is a continuation-in-part of International Application No. PCT/US2017/037561 filed Jun. 14, 2017, which is incorporated by reference herein in its entirety.

International Application No. PCT/US2017/037561 claims the benefit of U.S. Provisional Patent Application No. 62/349,836, filed Jun. 14, 2016, which is incorporated by reference herein in its entirety.

International Application No. PCT/US2017/037561 is a continuation-in-part of U.S. patent application Ser. No. 15/488,291, filed Apr. 14, 2017, which is incorporated by reference herein in its entirety.

This application is a continuation-in-part of U.S. patent application Ser. No. 15/682,478, filed Aug. 21, 2017, which is incorporated by reference herein in its entirety.

U.S. patent application Ser. No. 15/682,478 claims the benefit of U.S. Provisional Patent Application No. 62/377,840, filed Aug. 22, 2016, which is incorporated by reference herein in its entirety.

U.S. patent application Ser. No. 15/682,478 is a continuation-in-part of U.S. patent application Ser. No. 15/488,291, filed Apr. 14, 2017, which claims the benefit of U.S. Provisional Patent Application No. 62/323,140 filed Apr. 15, 2016, all of which are incorporated by reference herein it their entirety.

This application is a continuation-in-part of U.S. patent application Ser. No. 15/488,291, filed Apr. 14, 2017, which is incorporated by reference herein in its entirety.

U.S. patent application Ser. No. 15/488,291 claims the benefit of U.S. Provisional Patent Application No. 62/323,140, filed Apr. 15, 2016, which is incorporated by reference herein in its entirety.

### TECHNICAL FIELD

This disclosure relates generally to communications, and more specifically to electrical and optical interconnects for small and micro form factor devices.

### BACKGROUND

Small and micro form factor devices, such as mobile phones and tablets, offer limited modes of communication with other devices. It is common for such devices to have a single communications port configured to receive an electrical connector, as specified by one or more electronic communications standards. For example, many consumer electronics devices are limited to communicatively coupling with other devices, such as a personal computer or an audio/video system, through the available communications port using one or more communications standard, such as USB or HDMI. Adding communications ports for other standards or modes of communication may not be practical due to additional cost and the desire to maintain a small device size. As a result, other communications methods, such as optical communications, are not readily available in many small and micro form factor devices.

In certain such small and micro form factor devices, existing standards govern placement of certain electrical components within the devices. Such small and micro form factor device standards may also govern the amount of misalignment acceptable between a plug and a receptacle. However, as the operating speeds of devices increase, increases in communications speeds between the plug and receptacle is needed. Additionally, such improved communications speeds, if they conform to the existing standards, allows backward compatibility. Such backward compatibility is desirable as receptacles and/or plugs can continue to be used in older interfaces as well as newer interfaces. There is therefore a need for improved systems and methods for facilitating optical communications with backwards compatible small and micro form factor devices.

### BRIEF DESCRIPTION OF THE DRAWINGS

FIG. 1 is a block diagram of an exemplary optical interconnection system in accordance with an embodiment of the present disclosure.

FIG. 2 is a block diagram illustrating optical coupling loss through misalignment of optical axes in accordance with an embodiment of the present disclosure.

FIG. 3A is an exemplary plot of a flat top beam profile in accordance with an embodiment of the present disclosure.

FIG. 3B is an exemplary plot of a Gaussian beam profile in accordance with an embodiment of the present disclosure.

FIG. 3C is a plot of a cross section of an exemplary beam profile mask in accordance with an embodiment of the present disclosure.

FIGS. 3D and 3E are plots of exemplary passing and failing beam profiles, respectively, in accordance with an embodiment of the present disclosure.

FIGS. 4A and 4B are block diagrams illustrating exemplary non-zero gap coupling in accordance with an embodiment of the present disclosure.

FIG. 5 is an exemplary plot of a transmitting aperture diameter vs. collimated Gaussian beam range in accordance with an embodiment of the present disclosure.

FIG. 6A illustrates an exemplary eye mask of an electrical specification in accordance with an embodiment of the present disclosure.

FIG. 6B is a block diagram illustrating an exemplary electrical pin interface in accordance with an embodiment of the present disclosure.

FIG. 7 is an exemplary state diagram for device discovery in accordance with an embodiment of the present disclosure.

FIGS. 8A and 8B are block diagrams illustrating exemplary misalignment tolerances in accordance with an embodiment of the present disclosure.

FIGS. 9A, 9B and 9C are block diagrams of an exemplary communications port and corresponding connector in accordance with an embodiment of the present disclosure.

FIGS. 10A, 10B and 10C are block diagram of an exemplary communications port and corresponding connector in accordance with an embodiment of the present disclosure.

FIG. 11 is a block diagram of an exemplary optical passive component to optical passive component coupling in accordance with an embodiment of the present disclosure.

FIGS. 12A and 12B are block diagrams of exemplary hybrid electrical-optical plug and receptacle components in accordance with an embodiment of the present disclosure.

FIG. 13 is a perspective view of an exemplary hybrid electrical-optical interface in accordance with an embodiment of the present disclosure.

FIGS. 14A, 14B, 14C, 14D, 15A, and 15B are views of an exemplary hybrid electrical-optical plug in accordance with an embodiment of the present disclosure.

FIGS. 16, 17A, 17B, 17C, 17D, 18A, and 18B are views of an exemplary hybrid electrical-optical receptacle in accordance with an embodiment of the present disclosure.

FIG. 19 is a side view of an exemplary optical conduit in accordance with an embodiment of the present disclosure.

FIG. 20 is a block diagram of an exemplary hybrid electrical-optical interface in accordance with an embodiment of the present disclosure.

FIG. 21 is a flowchart detailing a method of operation of an exemplary hybrid electrical-optical interface in accordance with an embodiment of the present disclosure.

Aspects of the disclosure and their advantages can be better understood with reference to the detailed description that follows. It should be appreciated that like reference numerals are used to identify like elements illustrated in one or more of the figures, wherein showings therein are for purposes of illustrating embodiments of the present disclosure and not for purposes of limiting the same. The components in the drawings are not necessarily to scale, emphasis instead being placed upon clearly illustrating the principles of the present disclosure.

### DETAILED DESCRIPTION

In accordance with various embodiments of the present disclosure, systems and methods for interconnecting small and micro form factor devices through optical connections are provided. In one embodiment, a ferrule-less, non-contact, optical interconnect system and method is provided. The ferrule-less optical interconnect includes optical active components, including an optical beam source, such as a laser diode, for generating an optical beam meeting a minimum Gaussian beam profile, and a collimator for shaping a free space beam. The optical active components may also include a sink, such as a photodiode, and a condenser for focusing a free space beam. An optical connector includes optical passive components to receive the free space beam and shape the beam for propagation through an optical cable.

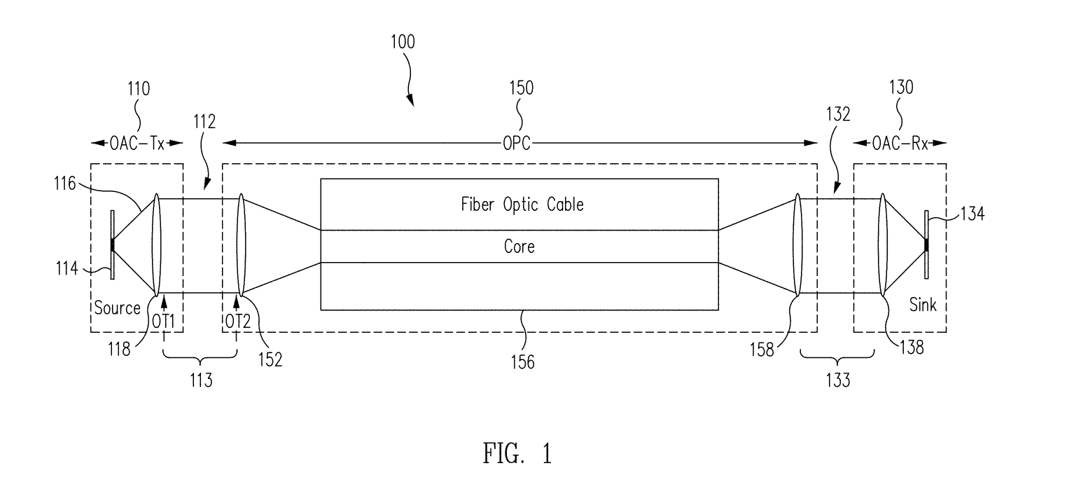

Referring to FIG. 1, an embodiment of an optical interconnect will be described. An optical interconnect system 100 includes an optical active components transmitter (OAC-Tx) 110, optical active component receiver (OAC-Rx) 130 and optical passive components (OPC) 150. In operation, the OAC-Tx 110 generates a free space beam 112 that travels through the gap 113 to a first end of the OPC 150. The OAC-Rx 130 generally uses a similar configuration for receiving a free space beam 132 formed by the OPC 150.

In one embodiment, the OAC-Tx 110 is disposed in a first host device, such as a mobile phone or tablet, and includes an optical source 114 that receives electrical signals from the host device and converts the electrical signals into an optical signal. In one embodiment, the optical source 114 includes a laser diode, such as a vertical cavity surface emitting diode (VCSEL), arranged to generate diverging optical beam 116. The OAC-Tx 110 further includes collimating lens 118 (collimator), which shapes the beam 116 to form collimated free space beam 112.

The OPC 150 includes a first lens 152, which receives the collimated free space beam 112 and focuses the beam for transmission through the core of fiber optic cable 156, and a second lens 158 for shaping the beam to form collimated free space beam 132 which travels across gap 133.

In one embodiment, the OAC-Rx 130 is disposed in a second host device, such as an A/V system, and includes an optical sink 134 that converts the received optical signal to electrical signals for processing by the second host device. In one embodiment, the OAC-Rx 130 includes a condenser lens 138 that focuses the collimated free space beam towards a photodiode (PD), which is arranged to sense the optical signal.

In an alternate embodiment, the OPC may include a conventional optical connector on one end, such as ferrule, for optically coupling with conventional optical devices. Further, each of the first host device and second host device may include one or more OAC-Tx and OAC-Rx components for bi-directional or multichannel communications. In various embodiments, the fiber optic cable may include a plurality of optical fibers and/or may be joined with electrical wires providing electronic communications in a hybrid arrangement. Although a single fiber optic cable is illustrated, the optical path between the OAC-Tx 110 and OAC-Rx 130 may include a plurality of OPCs coupled together.

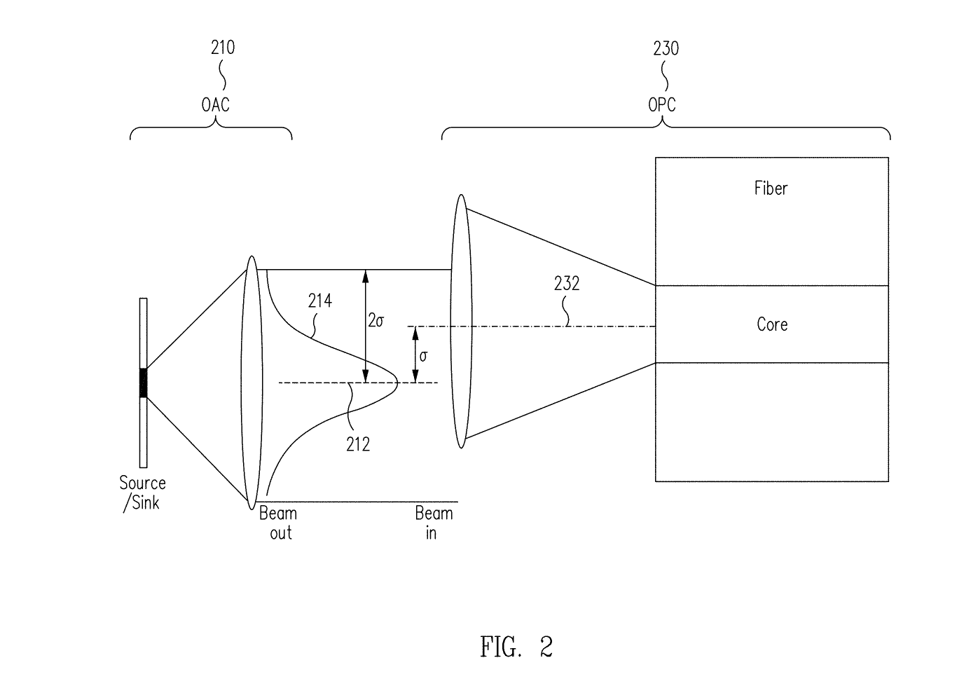

Referring to FIG. 2, alignment of the OAC and OPC will now be discussed with reference to the optical axis 212 of the OAC 210 and the optical axis 232 of the OPC 230. In various applications, coupling loss as illustrated might occur due to manufacturing or in field use (e.g., at a consumer's home). Misalignment of the optical axis 212 with the optical axis 232 can result in a loss of light energy and a disruption of communications. In the present embodiment, misalignment errors are attenuated, in part, by the selection and use of an optical beam profile suitable for use in the embodiment of FIGS. 1 and 2.

The exemplary optical beam profile disclosed herein will be understood with reference to the ray transfer matrix and use of the paraxial approximation of ray optics, including the paraxial wave equation with complex beam parameter. As illustrated, the collimated output beam 214 has a Gaussian power distribution profile, which minimizes coupling loss due to misalignment where the misalignment is by small amount relative to the overall beam diameter. In such cases, the misalignment affects mainly the tail parts of Gaussian distribution. In the illustrated embodiment, the loss is approximately 20% which is about 1 dB loss for 1σ misalignment.

Using a Gaussian beam profile has additional advantages including the availability of lasers with Gaussian beam profiles and the Gaussian waveform being a fundamental eigensolution for the paraxial wave equation used in some transceiver optical systems. However, many lasers produce beams that are non-ideal Gaussian. In one embodiment, a minimum Gaussian profile (MGP) is defined such that a non-Gaussian beam that satisfies the MGP can have reliable coupling power for an optical link as described herein.

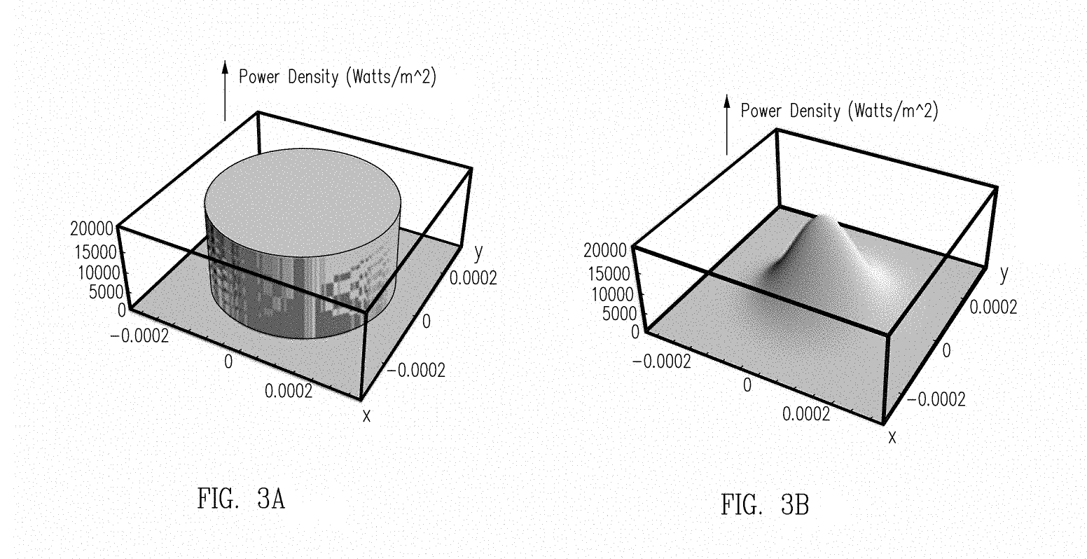

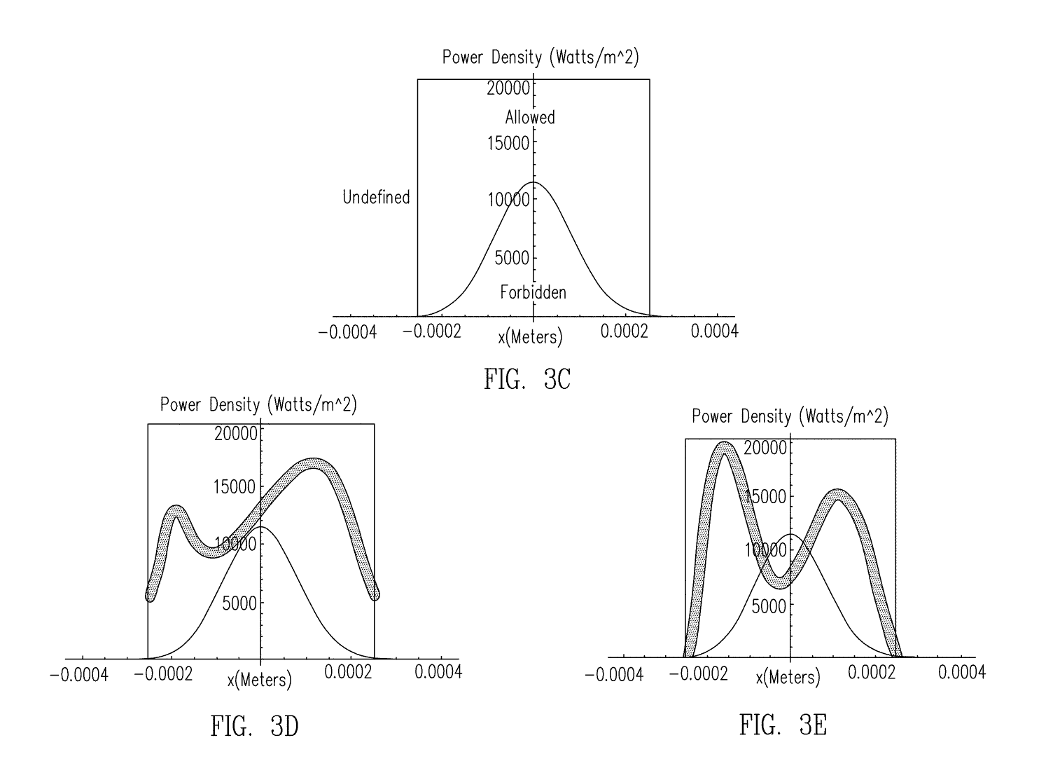

A beam profile mask is defined and explained below which includes details of Gaussian beam parameters in accordance with embodiments of the present disclosure. In one embodiment, the beam profile mask is comprised of a Flat Top Profile (FTP) as an upper bound and Minimum Gaussian. Profile (MGP) for the lower bound. The Flat Top Profile is given in the following equation and is illustrated in the exemplary 3-dimensional plot of FIG. 3A:

$$FTP ( x , y ) = 2.03718 \times {10}^{4} \times U ( 2.5 \times {10}^{- 4} - \sqrt{{x}^{2} + {y}^{2}} ) ( Watts \text{/} m 2 ) \\ where U ( t ) step function defined by , U ( t ) = \{ \begin{matrix}1 if t > 0 \\ 0 if t < 0\end{matrix} \qquad ( 1 )$$

The Minimum Gaussian Profile is given by the following equation and is illustrated in the exemplary 3-dimensional plot of FIG. 3B:

MGP(x,y)=1.14592×10⁴×e^{{-7.2×10}^{⁷}^{×(x}^{²}^{+y}^{²}^{)}} (Watts/m2) (2)

FIG. 3C shows a cross section of the mask at y=0. Exemplary profiles that have passed and failed are shown in FIGS. 3D and 3E, respectively.

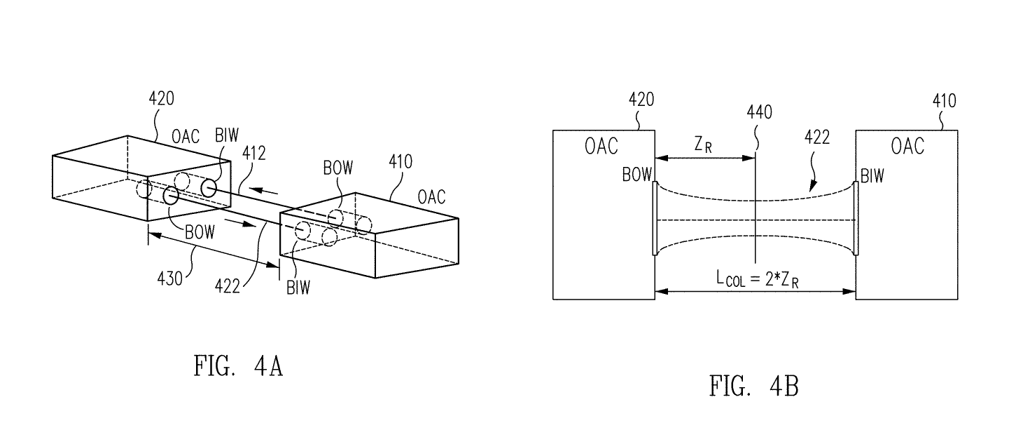

In various embodiments, non-zero gap (NZG) optical coupling between the optical active components and optical passive components is used. Non-zero gap (NZG) optical coupling will be described in further detail with reference to FIGS. 4A and 4B. By using NZG, burdens on consumer electronics manufactures to add optical receptacles and invest in precision equipment for proper alignment of conventional optical interconnects is alleviated.

FIG. 4A is an embodiment of a direct, free space, bi-directional communication channel in accordance with the present disclosure. As illustrated, each channel, 412 and 422, is implemented using a free space Gaussian beam (ideal or non-ideal Gaussian beam as described herein) from transmitter to receiver between two chips, 410 and 420, respectively. In this embodiment, both chips are sufficient aligned physically with each other and the beams do not substantially diverge or converge. The non-zero gap 430 of the present embodiment allows spacing between the beam output window (BOW) and the beam input window (BIW) when the light signal is traveling off-chip (i.e. off-OAC).

In practice, a spatially coherent Gaussian beam diverges, and ideal collimation is not possible. Referring to FIG. 4B, in one embodiment the beam is substantially collimated to provide minimal focusing such that the beam waist 440 is located in the middle of L_{col}, and such that beam diameter at BOW and BIW are both increased from the diameter of the beam waist. In one embodiment, the beam diameter at BOW and BIW are both increased by the square root of the beam waist radius. In the illustrated embodiment the collimation length, L_{col}, is related to the Rayleigh range—the distance from the waist 440 of the beam to the point at which the area of the cross section of the beam is doubled. L_{col} may be defined for any OAC such that the beam waist is located in the middle of L_{col} such that beam diameter at BOW and BIW are both greater than the beam waist diameter and increasing from the beam waist. Here, the Gaussian beam output from the transmitter of OAC 420 is collimated up to minimum 100 mm such that L_{col}≥100 mm.

In one embodiment, optical beam characteristics are based on paraxial approximation where the ray angle (θ) from an axial (z-axis) direction holds the following approximation, tan θ≅θ. Beam parameters and related definitions can be found in industry standard, ISO11146-2, which describes laser beam characteristics using second order moments of the Wigner distribution, and is incorporated by reference herein in its entirety. Theoretically, this can be used on any optical beam, regardless of where it is Gaussian or non-Gaussian, fully coherence or partially coherence, single mode or multiple transverse mode.

Exemplary beam parameters for the illustrated embodiment are set forth below:
i. D_{beam} (Beam waist: D4σ)=4σ, where σ is defined at z₀ by

$$σ = \sqrt{\frac{{\int }_{- ∞}^{∞} {\int }_{- ∞}^{∞} {( x - {x}_{0} )}^{2} I ( x , y ) dxdy}{{\int }_{- ∞}^{∞} {\int }_{- ∞}^{∞} I ( x , y ) dxdy}} \qquad ( A 1 )$$

and I(x,y) is optical power density at beam waist location, z₀, of beam with ε (Beam Ellipticity≡d_{σ(short}_{_}ₐₓᵢₛ₎/d_{σ(long}_{_}ₐₓᵢₛ₎) being less than 0.87 (see ANSI 11146-1)
ii. θ_{f} (Divergence Full Angle)=2×θₕ, where θₕ is half angle of beam divergence (subtending angle from origin to 2σ of far field Gaussian profile)
iii. BPP (Beam parameter product)=w₀×θₕ (A2)
iv. M² (Beam propagation ratio)=π×BPP/λ

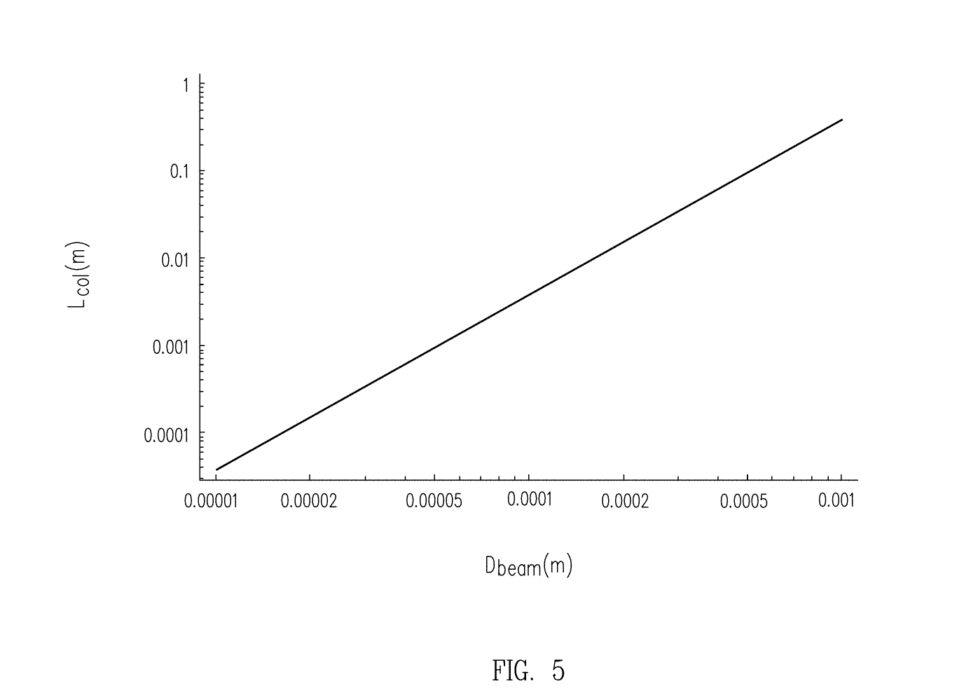

The optical interface in the connector is specified by the Beam Parameter Product (BPP) defined by

$$BPP ≡ \frac{{D}_{beam @ OT 1} \times {θ}_{max}}{4}$$

where D_{beam@OT1} is the beam diameter of 4σ, θₘₐₓ is beam divergence at BOW (beam output window) of the optical transmitter assuming the beam is stigmatic, and OT1 is a first optical test point (see, e.g., FIG. 1). For example, diffraction limited Beam Parameter Product, BPPg, can be achieved for ideal Gaussian Beam for λ=850 nm which is approximately BPPg=0.271 mm·mrad. FIG. 5 shows an exemplary plot for the transmitting aperture diameter (D_{beam}) vs. the collimated Gaussian beam range (L_{col}) for a Gaussian beam of the same wavelength.

The illustrated embodiment allows beam distortions from OT1 signal due to ULPI (unintentional light path impairment) such as misalignment, reflection, bending, thermal distortion of optical media including air, dust etc. Thus, beam parameters in the illustrated system at optical test point 2 (OT2, the optical location at BIW) allows the increase of BPP (as also described below in terms of M² value). The tables, below, summarize an exemplary specification for related parameters at OT1 (BOW) and OT2 (BIW):

Optical beam specification at OT1

| | Min. | Typ. | Max. |
|---|---|---|---|
| D_{beam@oT1}(um) | 450 | 500 | 550 |
| θₘₐₓ(mRad/°) | | 10/0.57 | 22/1.26 |
| BPP (mm · mrad) | BPPg@850 nm | 1.25 | 3.0 |

Optical beam specification at OT2

| | Min. | Typ. | Max. |
|---|---|---|---|
| D_{beam@oT2}(um) | 450 | 500 | 550 |
| θₘₐₓ(mRad/°) | | 30/0.57 | 66/1.26 |
| BPP (mm · mrad) | BPPg@850 nm | 3.75 | 9.1 |

The present embodiment allows maximum M² increase (MSI) through the light path through which the signal beam travels from OT1 to OT2 via any OPC (optical passive component) or ULPI (unintentional light path impairments). Thus, the light path in the present embodiment meets the following MSI specification: minimum MSI=1.0 (0 dB); maximum MSI=3.0 (4.7 dB).

Exemplary total signal power for OT1 and OT2 in the present embodiment are set forth in the following table, in which the total power of a collimated beam is defined within the circle having the diameter of D_{beam@oT1} and D_{beam@oT2}, respectively:

| | Min. | Typ. | Max. |
|---|---|---|---|
| OT1 (ouput) | −3 dBm | −2 dBm | 1 dBm |
| OT2 (input) | −9 dBm | −3 dBm | 0 dBm |

It will be appreciated by those having skill in the art that this optical signal specification provides advantages in link performance such as BER or analog noise when collimating and focusing correctly.

One goal of the present embodiment is to make use of commonly accessible electrical interfaces that are commonly available for use on small devices and accessible by existing electrical Serializer/Deserializer (SERDES) components used in high speed communications, such as using existing USB and/or HDMI interface components through minimal passive (or non-) modification by external circuit introduction.

Exemplary electrical specifications for the illustrated embodiment are set forth below.

| | |
|---|---|
| Power ground rail | 1.8 V TX/RX interface |
| Bandwidth | f_{MFP}(bps) capabilities = 10 G; 12.5 G; 25 G |
| T_{bit} | T_{bit} ≡ 1/f_{MFP}: 100 ps; 80 ps; 40 ps |
| TX differential input at | 600 mVpp/1000 mVpp |
| T1: min/max | |
| Rx differential output at | 300 mVpp/500 mVpp |
| T2: min/max | |
| Eye-width (Jitter and | Tx input jitter allowed: Jt > 0.4UI |
| skew) | Rx output jitter max: Jt < 0.5UI |
| | Intra pair skew generation at Rx: <0.05 UI |

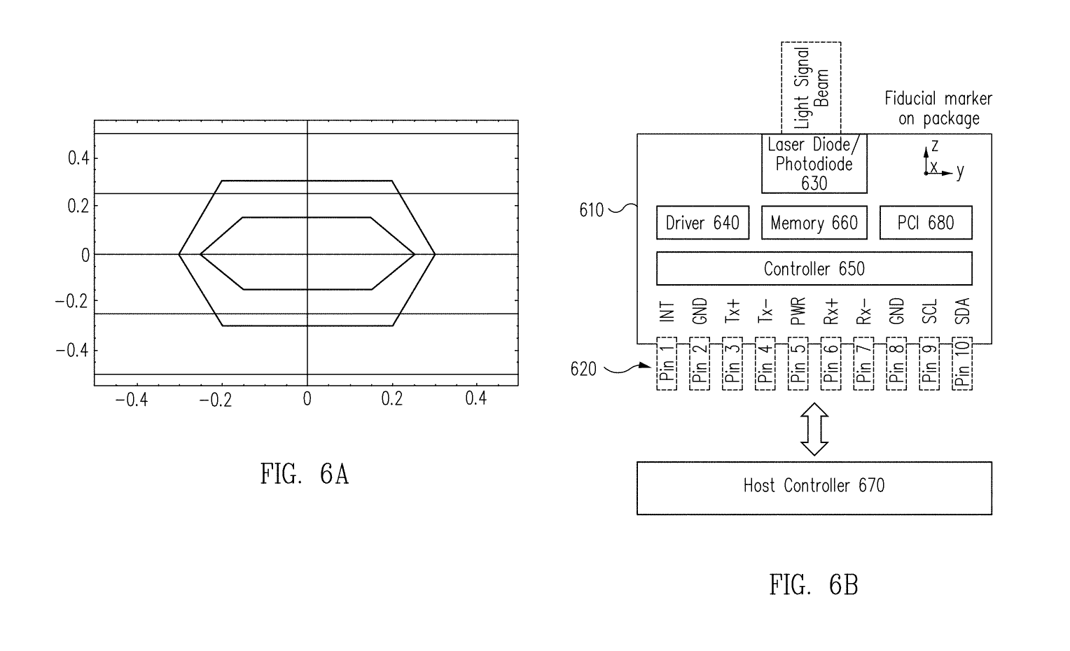

These specifications may not be ideal to electrically drive (or be driven by) a cable connector in many applications, but are sufficient to drive board trace of minimal 10 cm in tested embodiments. FIG. 6A illustrates an eye mask of the exemplary electrical specification.

FIG. 6B illustrates an exemplary semiconductor package 610 and electrical I/O pins 620. In one embodiment, I²C is used as a control interface to control local micro form factor photonics. The mechanical assembly may include a fiducial marker for reference in aligning the beam path. Depending on the implementation, the package 610 may function as a transmitter, receiver or transceiver and include one or more laser diodes/photo diodes 630, a driver 640, controller 650, memory 660 (which may be implemented as volatile or non-volatile memory, including a non-transitory computer readable medium) and other circuitry and logic, as appropriate. The device is generally controlled by an I²C interface for set-up, loss of signal (LOS), hot-plug detect, device discovery, contention resolution and other operational features. These and other operations may be implemented through a combination of dedicated circuitry and components and program logic stored in memory 660 for implementation by controller 650. In addition to two I²C pins, INT pin is provided to interrupt any process when it requires by local controller 650 or a remote processor, such as host controller 670.

In one embodiment, the controller 650 monitors loss of signal and whether the optical receiver receives proper level of optical power to avoid performance targets of bit error rate or analog signal to noise ratio. The loss of signal may also be tracked for safety to avoid the optical beam straying around non-defined optical path such that human eyes can be exposed or other safety concerns avoided. Optical power level is recommended to be set at Pₗₒₛ (of −12 dBm for example) at Rx through I²C.

A hot-plug of an optical link may be detected optically by monitoring optical power as long as both Tx and Rx are electrically powered through beacon light coming out from Tx and sensed at Rx with optical power of P_{bcn}=Pₗₒₛ−3 (informative). Therefore, normal operation of an optical link may discriminate whether the optical input is a relative drop due to loss of service or absolute changes of all optical input power including signal power level compared to the setting values described above.

In one embodiment, device discovery is achieved through a photon-copper interworking (PCI) block 680, which emulates auxiliary interface functions such as device discovery or other upper layer protocols. There are certain physical layer issues to translate the analog electrical signal into optical domain. The present embodiment defines a new functional block in-between electrical-to-optical interface to fulfill the link set-up process. The PCI block 680 is implemented to translate such functions in which case the information of electrical connect (or disconnect) is transferred to the optical domain, and vice versa. Although in the optical domain there are many possible ways to transmit and receive the bi-directional information on one optical fiber, the media should be transferred in-between optical and electrical. Thus a simplified processing controller for such purpose is recommended to implement such PCI with two wire communications in between.

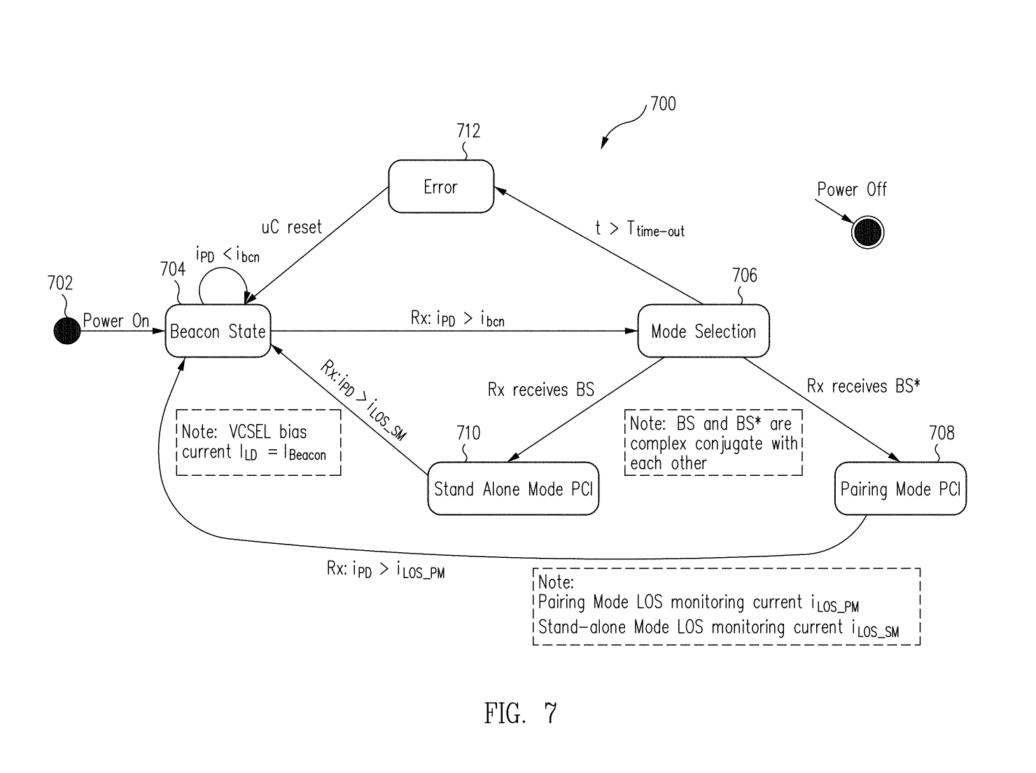

An embodiment of a beacon to PCI state diagram 700 is illustrated in FIG. 7. At 702, the optical components are powered on and the beacon state is detected in block 704. Control remains at block 704 while the current measured at photodiode, i_{PD}, is less than a beacon current threshold, i_{bcn}. If the device receives an optical signal such that i_{PD}>i_{bcn} then control is passed to the mode selection block 706. In standalone mode PCI 710, a loss of service process monitors current at the photodiode and compares the measured current to a standalone mode LOS threshold, i_{LOS}_{_}_{SM}. Control passes to beacon state 704 when i_{PD}>i_{LOS}_{_}_{SM}. In the pairing mode PCI block 708, a loss of service process monitors current at the photodiode and compares the measured current to a pairing mode LOS threshold, i_{LOS}_{_}_{PM}. Control passes back to beacon state 704 when i_{PD}>i_{LOS}_{_}_{PM}. If mode selection 706 times out, control passes to error block 712 which sends resets signal and control passes back to beacon state 704.

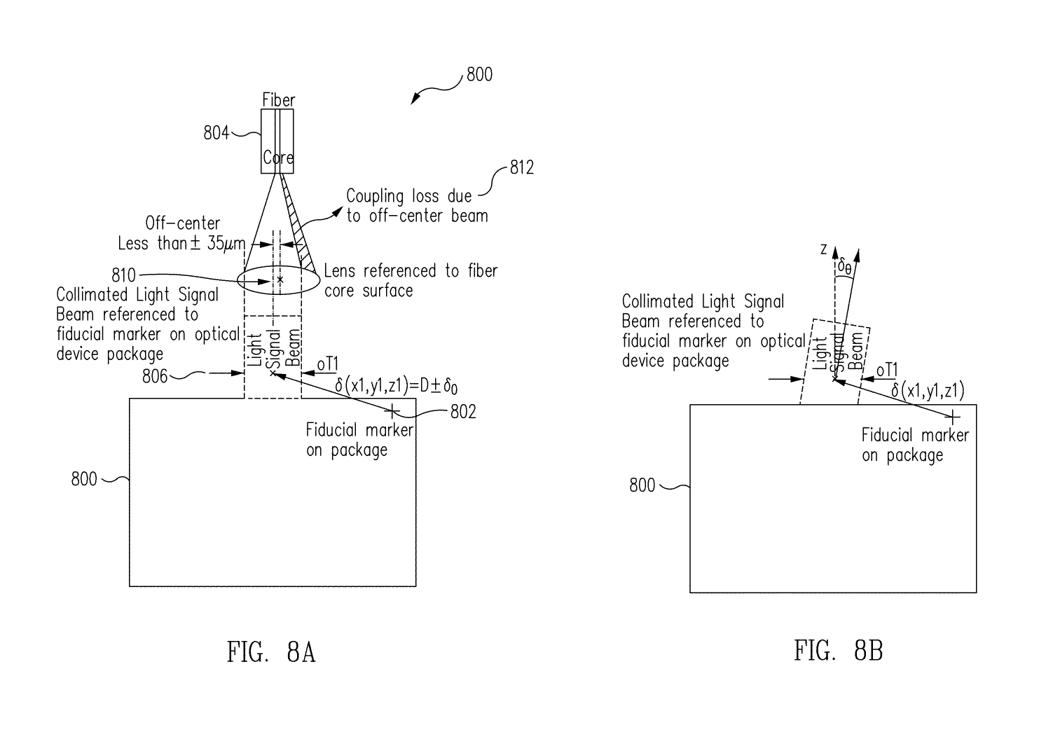

Referring to FIGS. 8A and 8B, misalignment errors will be discussed in further detail. FIG. 8A illustrates an exemplary optical device package 800 with a reference point 802 for aligning the light signal beam with the core of an optical fiber 804. In one embodiment, the maximum displacement target between the core and the optical device package is δ₀=35 μm for reliable communications. As illustrated, a misalignment 810 by 35 μm or less would yield coupling loss 812 that still allows for reliable communications performance in accordance with the specifications herein. FIG. 8B illustrates misalignment due to angle of displacement. In one embodiment, the maximum angular displacement with reference to the desired beam path is δ₀=0.35 mrad.

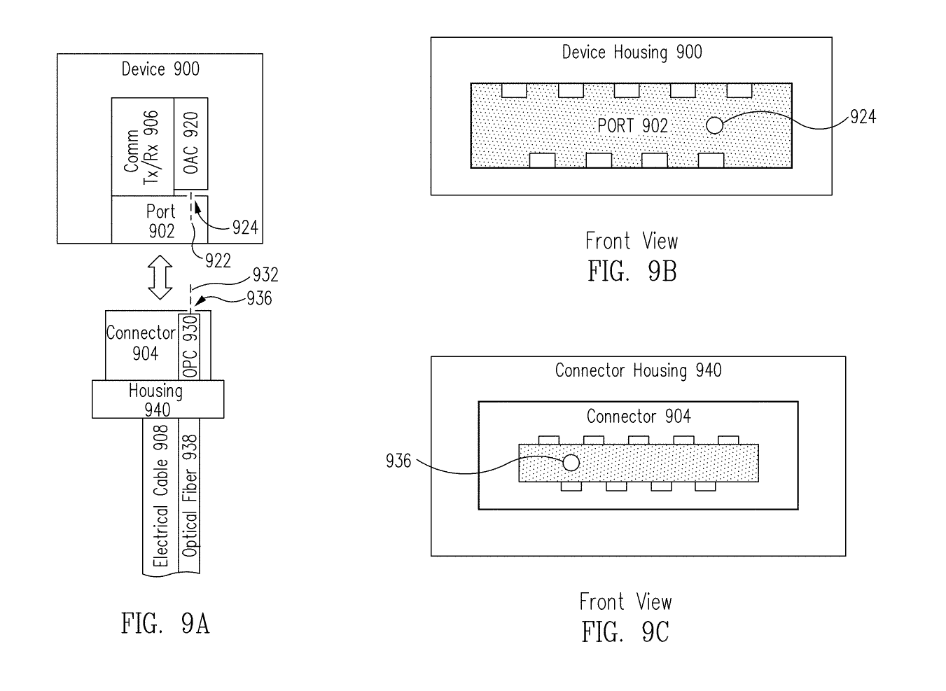

Referring to FIGS. 9A, 9B and 9C, an interconnect system implementing the present disclosure will now be described. A device 900, such as a mobile telephone, includes a communications port 902 for receiving a corresponding connector 904. The port 902 is controlled by communications transceiver (Tx/Rx) components 906, which facilitates communications between the device 900 and another device (not shown) through the communications cable 908. In various embodiments, Tx/Rx 906, port 902, connector 904 and cable 908 are configured to provide communications in accordance with a digital or analog electrical communications standard, such as HDMI or USB.

For many devices, it is desirable to maintain a small form factor and adding additional ports is not a desirable option. In the illustrated embodiment, optical active components (OAC) 920 are provided, including an optical source that generates a beam along beam path 924. In other embodiment, the OAC 920 may include an optical sink that receive a beam along beam path 924. To facilitate the optical communications, the port 902 includes a hole 924 sufficient to allow the beam to travel from the OAC 920, through the hole and into the port 902 along beam path 922. The connector 904 includes corresponding optical passive components (OPC) 930 arranged such that optical path 932 is aligned with optical path 922 when the connector 904 is inserted and communicably coupled with the port 902 for electrical communications.

Referring to FIGS. 9B and 9C, the holes 924 and 936 may be positioned at an available location in the port 902 and on connector 904, respectively. The positions of the holes will vary depending on the arrangement of connector and availability of free space for the optical beam path. The alignment of the connector 904 in port 902 allows the holes 924 and 936 to substantially align for optical communications allowing for non-zero gap optical coupling. The OAC 920 can be positioned within the circuitry of the device 900 and the OPC 930 can be positioned within the connector 904 and/or connector housing 940 and is coupled to an optical fiber 938, which is combined with electrical cable 908 to form a hybrid electrical/optical cable and connector.

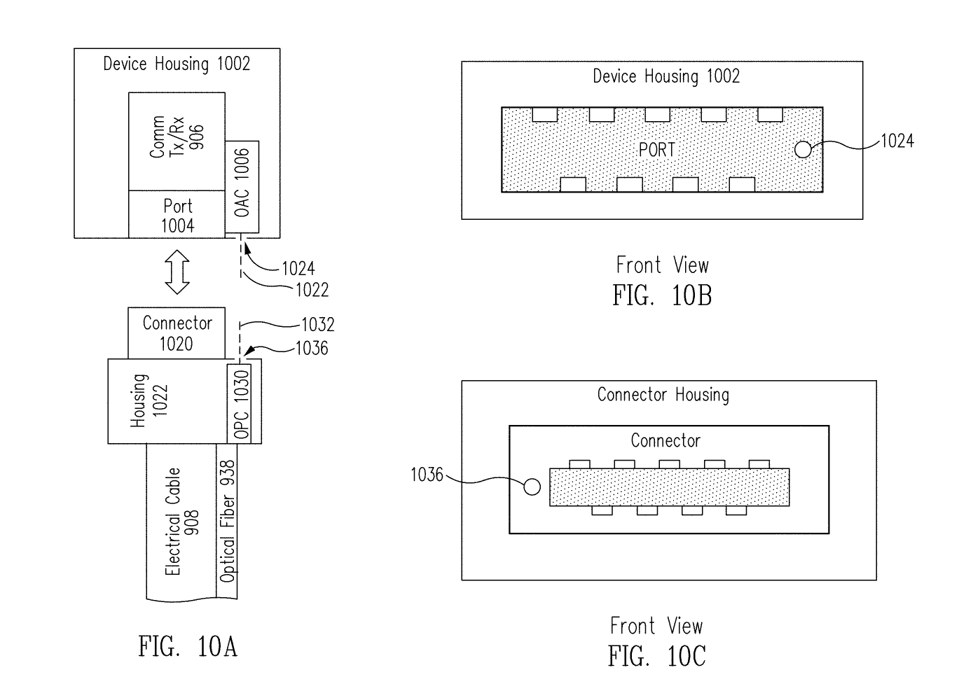

Some interconnect technologies don't provide sufficient open space in the port allowing for optical communications. In one embodiment, the electrical components may be removed from the connector to open up free space in a dedicated optical interconnect cable. In another embodiment, the beam path may be moved to the housing adjacent to the port. Referring to FIGS. 10A, 10B and 10C, a hole 1024 is provided in device housing 1002, adjacent to the port 1004. OAC 1006 is aligned adjacent to the hole 1024 allowing the beam to travel along free space beam path 1022. When the connector 1020 is inserted into the port 1004, the connector housing 1022 is positing against or adjacent to the device housing 1002. The connector housing 1022 includes OPC 1030 for transmitting or receiving an optical beam through a hole 1036 in the connector housing 1022, along a beam path 1032, which is substantially aligned with optical path 1022 for optical communications.

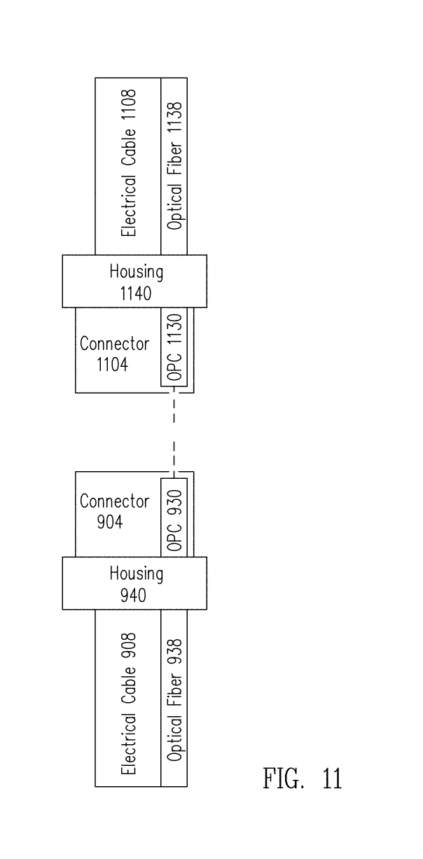

Referring to FIG. 11, an exemplary embodiment of OPC to OPC coupling will now be described. In various embodiments, the OPC 930 may be optically coupled to optical passive components, such as optical passive components 1130. In the illustrated embodiment, the optical passive components 1130 are housed in a hybrid electrical/optical cable and connector including an electrical connector 1104, adapted to receive connector 904 to form an electrical coupling, an electrical cable 1108, a housing 1140 and optical fiber 1138. This arrangement can be used, for example, to connect two or more optical cables in series.

Reference is now made to exemplary hybrid electrical-optical universal serial bus (USB) interfaces. Such hybrid electrical-optical USB interfaces may include at least a plug and a receptacle that each include one or more optical conduits and/or electrical conduits configured to pass associated optical and/or electrical signals.

The optical conduits may allow communication of data at a higher rate than conventional electrical conduits and, accordingly, allow for a faster version of a USB interface. In certain examples, such optical conduits may be configured to transmit optical signals (e.g., light and/or laser signals). Such optical conduits may be implemented with any appropriate optical media to transmit optical signals. Such optical media may include, for example, one or more OPCs, OACs, fiber cables, waveguides, and/or other components for communication of optical signals. Certain embodiments of the hybrid electrical-optical USB interfaces can be USB Type C interfaces, but other embodiments may include other types of USB interfaces.

The electrical conduits may be implemented with any appropriate conductive media to transmit electrical signals. Such conductive media may include, for example, electrical cables, traces, vias, and/or other appropriate components for communication of electrical signals.

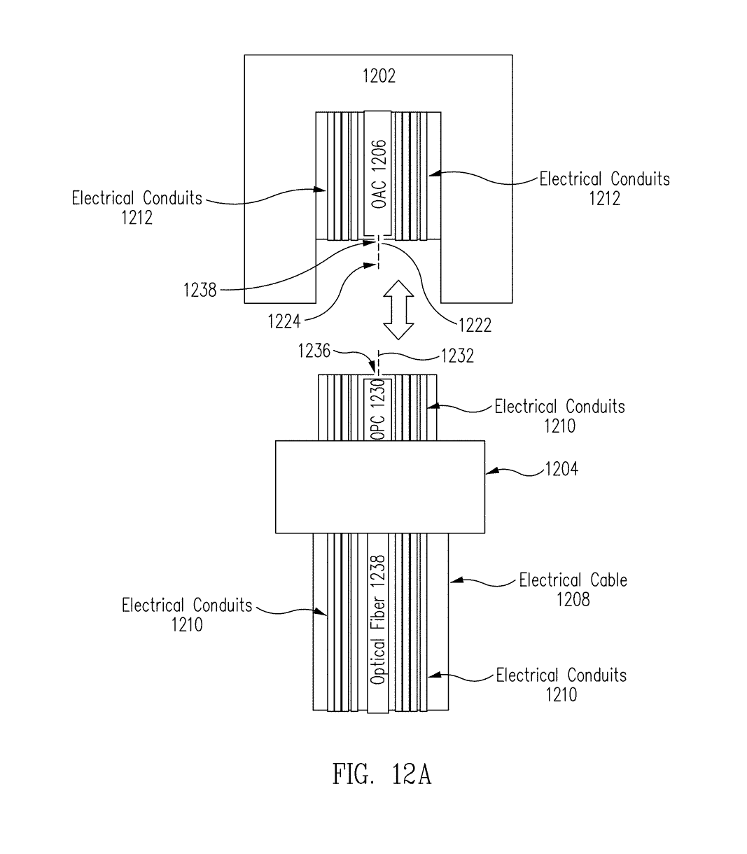

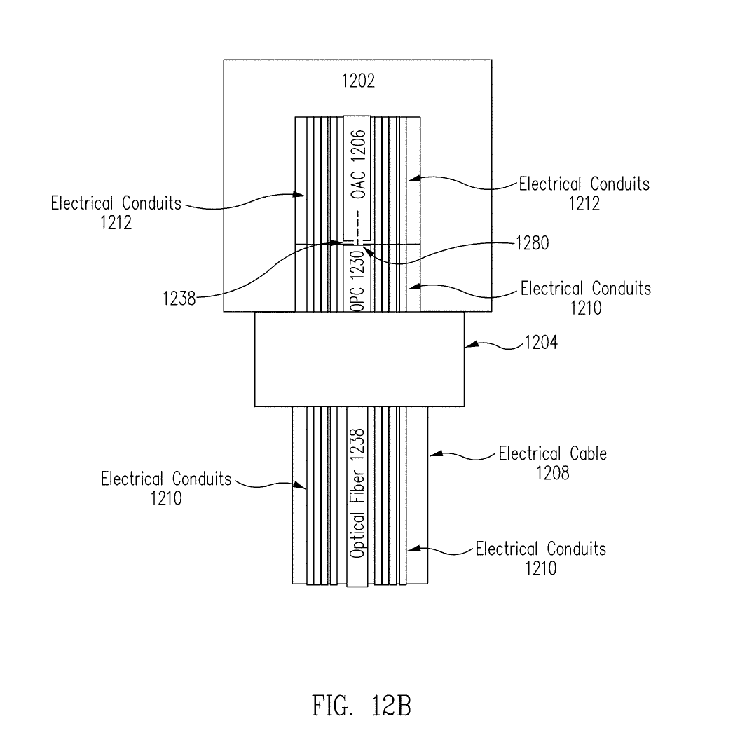

Referring to FIGS. 12A and 12B, an exemplary hybrid electrical-optical interface will now be described. FIGS. 12A and 12B include hybrid electrical-optical receptacle 1202 and hybrid electrical-optical plug 1204. The plug 1204 includes a connector body that includes electrical conduits 1210, OPC 1230 and optical fiber 1238.

The OPC 1230 may be at least partially disposed within, for example a central region. The OPC 1230 are disposed within the connector body of the plug 1204 and are aligned with hole 1236 to transmit or receive optical beams along beam path 1232 so that the connector body does not interfere with the beam path 1232.

The receptacle 1202 includes OAC 1206 for transmitting or receiving an optical beam along beam path 1222. The OAC 1206 may be disposed within the receptacle 1202. Certain embodiments may position the OAC 1206 within a cavity of the receptacle 1202 behind hole 1238. Hole 1238 is configured so as not to interfere with the beam path 1222.

The electrical conduits 1210 of the plug 1204 are configured to interface with electrical conduits 1212 of the receptacle 1202 to form an electrical coupling to transmit and/or receive communications via electrical signals. At least some of the electrical conduits 1210 are disposed in peripheral regions around the central region of the plug. As such, the OAC 1206 and 1230, as well as optical fiber 1238, may be disposed between at least two of the electrical conduits.

In FIG. 12B, when the plug 1204 is mated to the receptacle 1202, the plug 1204 and the receptacle 1202 are positioned relative to each other such that there is a free space gap between OPC 1230 and OAC 1206. The plug 1204 and/or the receptacle 1202 may be configured to produce such a free space air gap 1280 (e.g., by positioning the OPCs 1230 and OAC 1206 within the connector body behind the holes 1236 and 1238). In such a configuration, the OAC 1206 may be optically coupled with OPC 1230. Thus, the beam axes of OAC 1206 and OPC 1230 may be aligned or may include acceptable misalignment errors that are attenuated, in part, by the selection and use of an optical beam profile as described herein. Additionally, when mated, the electrical conduits 1210 are interfacing with electrical conduits 1212 to form electrical couplings.

In various embodiments, the plug 1204 and the receptacle 1202 may include maximum misalignment specifications. The OAC 1206 and/or OPC 1230 may be configured so that optical data transfer is maintained even when the plug 1204 and the receptacle 1202 are misaligned to the maximum allowed under specifications. As such, in certain embodiments, the OAC 1206 and/or OPC 1230 and/or the beam power and/or profile of the optical beams are configured to pass optical beams with the beam profiles described herein (e.g., in FIGS. 3A-E) even when the plug 1204 and the receptacle 1202 are maximally misaligned (e.g., by the shaping and/or sizing of the OAC 1206 and/or OPC 1230, and/or through powering and/or shaping the beam). OPC 1230 are optically connected to optical fiber 1238.

Certain embodiments may directly couple OPC 1230 to optical fiber 1238. As shown in FIGS. 12A and 12B, OPC 1230 is disposed between portions of the electrical conduits 1210 in a forward portion of the plug 1204. The OPC 1230 can be optically coupled to the optical fiber 1238. The optical fiber 1238 can extend rearward such that the optical fiber 1238 is disposed between the electrical conduits 1210. In certain embodiments, the electrical conduits 1210 are at least partially disposed around the optical fiber 1238. Such a configuration may provide protection to the optical fiber 1238 to prevent mechanical failure. Other embodiments can dispose the optical fibers in other configurations, such as around the electrical conduits 1210 and/or within the electrical conduits 1210.

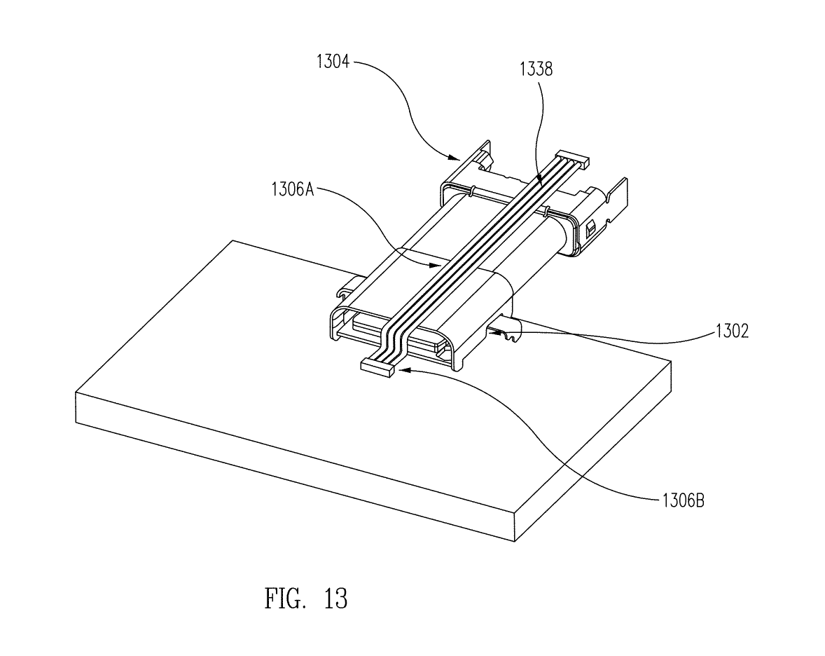

Referring to FIG. 13, the plug 1304 and the receptacle 1302 are mated. Optical conduits 1338 and 1306A are in optical communication. As such, an optical beam is passed through optical conduits 1338 and 1306A. Additionally, as shown in FIG. 13, the receptacle 1302 includes optical conduit 1306B that are in optical communication with optical conduit 1306A. As shown, the optical conduit 1306B is configured to bend downward and, thus, change the path of the optical beam.

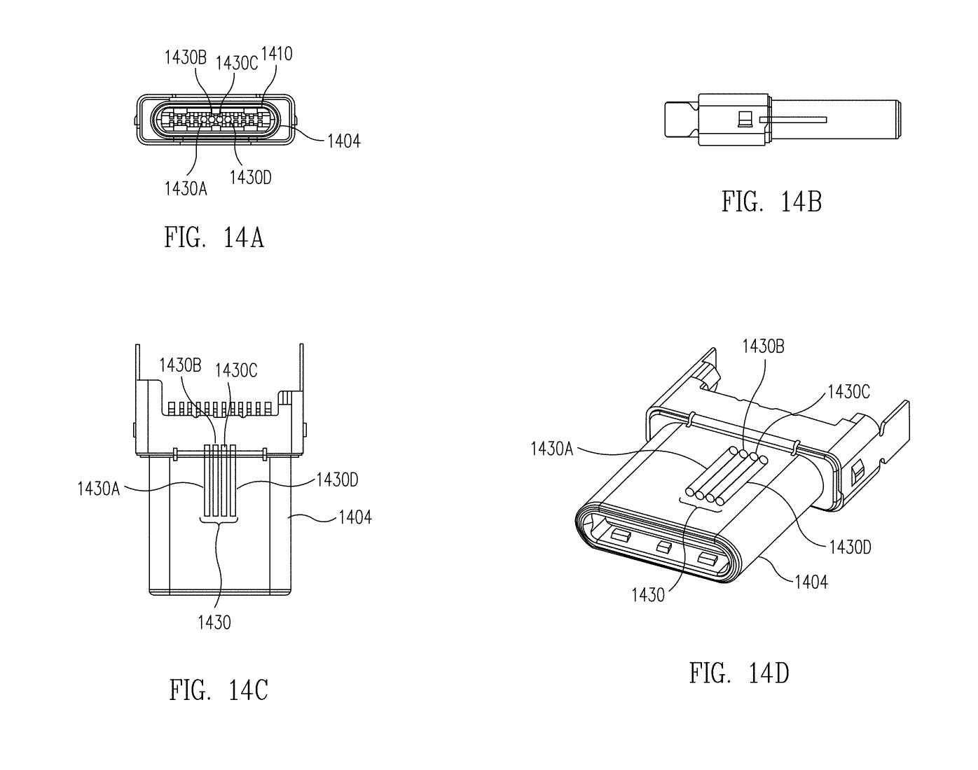

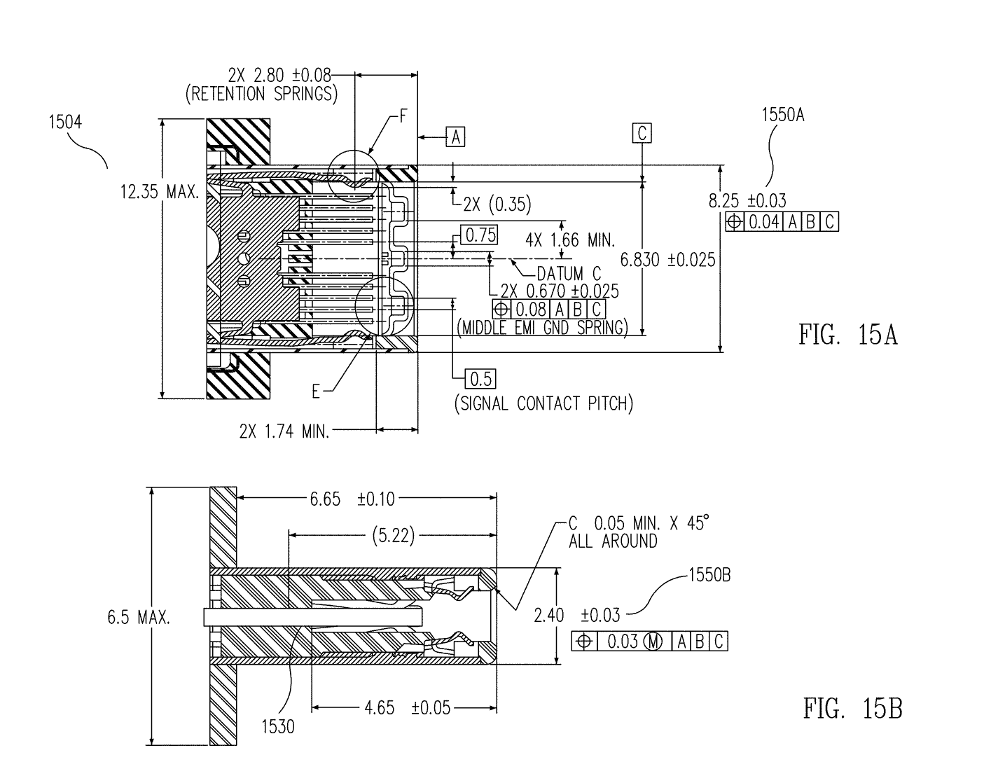

Referring to FIGS. 14A, 14B, 14C, and 14D, 15A, and 15B, a hybrid electrical-optical plug is shown. FIGS. 14A-D shows multiple views of plug 1404 with optical conduit 1430 disposed within a central region of the plug 1404. FIG. 14A shows a front view of the plug 1404. FIG. 14B shows a side view of the plug 1404. FIG. 14C shows a top view of the plug 1404. FIG. 14D shows a perspective view of the plug 1404.

As shown, optical conduit 1430 includes multiple individual optical conduits 1430A-D, each of which may include individual lenses and optical fibers. Certain embodiments may dispose electrical conduits off to one or more sides of the optical conduits 1430A-D. Such a configuration is shown in FIG. 14A, which shows the optical conduits 1430A-D disposed between electrical conduits 1410. In certain embodiments the OPC and optical fiber assembly and/or each OPC and optical fiber can be referred to as an optical conduit.

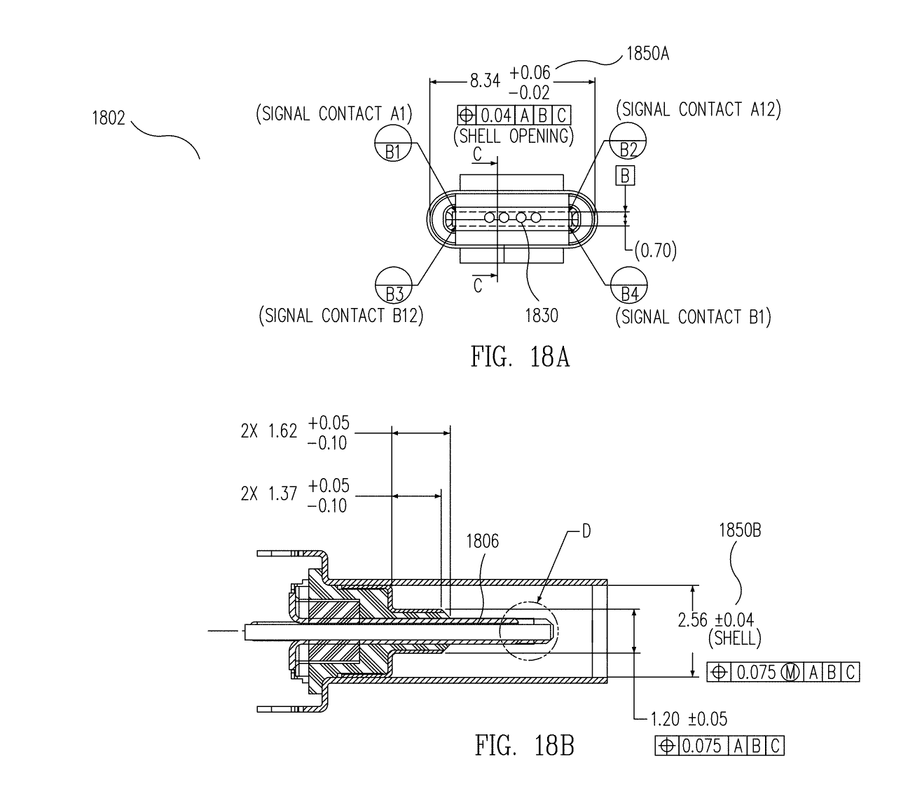

Various drawings of the present disclosure (e.g., FIGS. 15A, 15B, 18A, and 18B) include mechanical dimensional specifications of various plugs and receptacles. Such specifications include dimensions and locations of various features of the plugs and receptacles, as well as tolerance standards. For purposes of the present disclosure, such dimensions and tolerances are provided in millimeters. Such drawings also depict combinations and subcombinations of such dimensions and tolerances.

Moreover, drawings of the present disclosure depict combinations and subcombinations of the relative locations of the various illustrated optical and electrical components in relation to each other and in relation to the mechanical features of connector bodies (e.g., including plugs and receptacles) for various implementations. In particular, FIGS. 13 to 18B depict various combinations and subcombinations for USB Type C implementations.

FIG. 15A shows a top cutaway view of the plug 1504 that includes mechanical dimensional specifications. FIG. 15B shows a side cutaway view of the plug 1504. FIGS. 15A and 15B show a universal serial bus (USB) configuration plug. As shown the plug may be a USB Type C plug. As shown in FIGS. 15A and 15B, the plug 1504 includes width and height specifications 1550A and 1550B, respectively. Width and height specifications 1550A and 1550B includes tolerance values that determine a maximum and minimum dimensional specification for the width and height of the plug 1504.

The plug 1504 also includes optical conduit 1530. The optical conduit 1530 can be configured to receive an optical signal in a forward portion of the plug 1504 and run toward a rear portion of the plug 1504. To ensure backwards compatibility, optical conduit 1530 may be placed so that the form factor of the plug 1504 is not substantially disturbed and so the plug 1504 can be mated with a corresponding receptacle that does not include optical conduits.

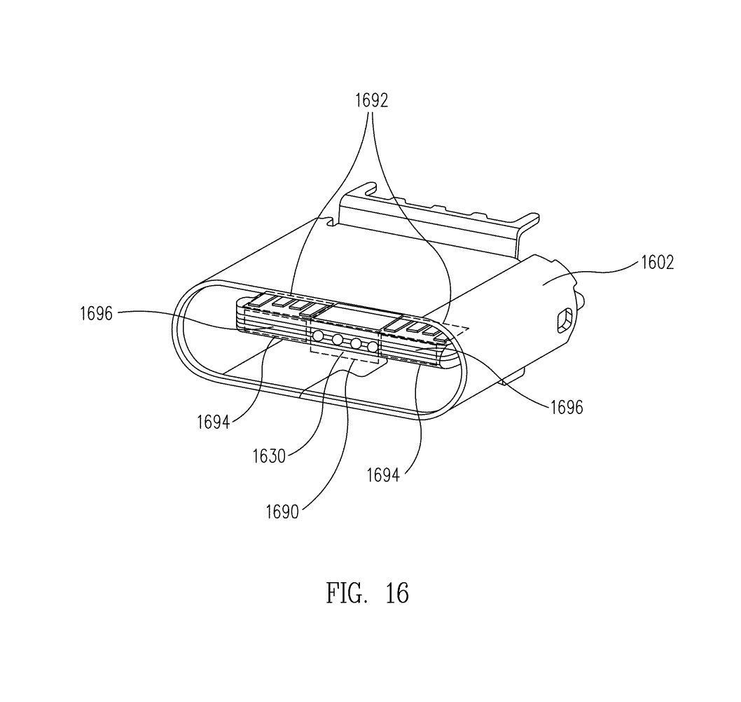

FIG. 16 shows a hybrid electrical-optical receptacle 1602 that includes a central region 1690 that the optical conduit 1630 is disposed within. The receptacle 1602 also includes super speed electrical regions 1692 that may include electrical conduits configured to communicate high speed electrical signals. As such electrical conduits can include vias, regions 1694 may be configured to protect from crosstalk noises. As such, optical conduit 1630 may be configured to avoid the regions 1694 underneath the super speed electrical regions 1692. In certain embodiments, regions 1694 may include one or more physical structures (e.g., midplates 1696) which may prevent optical conduits 1630 from being disposed within the regions 1694 and/or to reduce crosstalk.

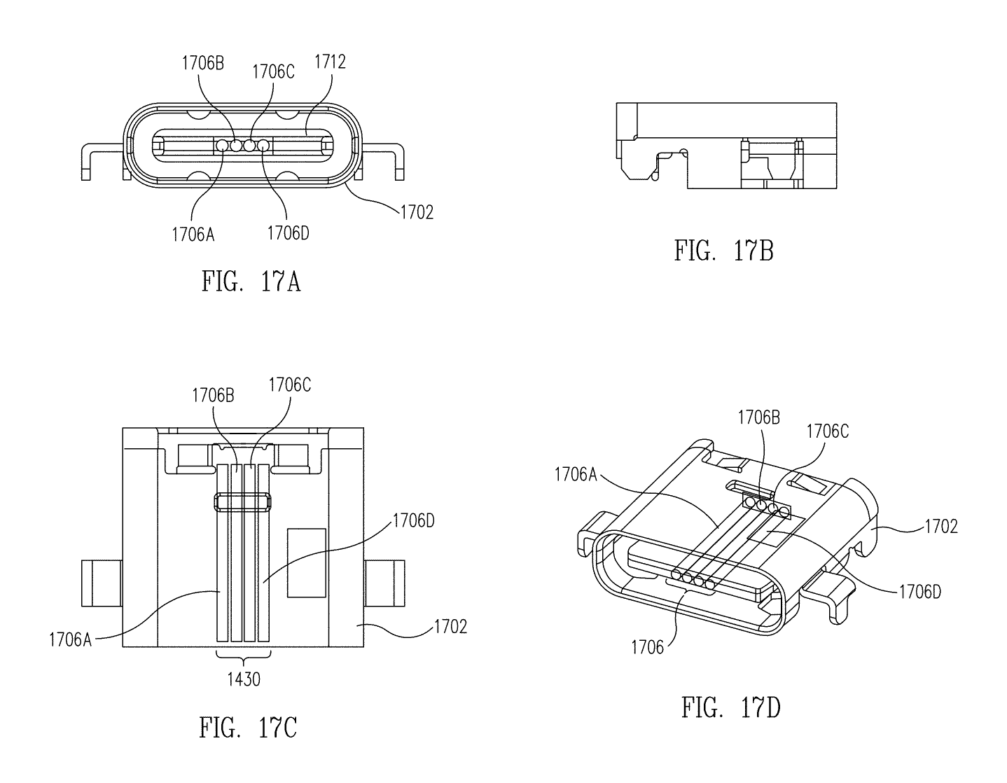

Referring to FIGS. 17A, 17B, 17C, 17D, 18A, and 18B, a hybrid electrical-optical receptacle is shown. FIGS. 17A-D shows multiple views of receptacle 1702 with optical conduit 1706 disposed within a central region of the receptacle 1702. FIG. 17A shows a front view of the receptacle 1702. FIG. 17B shows a side view of the receptacle 1702. FIG. 17C shows a top view of the receptacle 1702. FIG. 17D shows a perspective view of the receptacle 1702.

FIGS. 17A-D show multiple views of receptacle 1702 with optical conduit 1706 disposed within a central region of the receptacle 1702. Optical conduit 1706 includes multiple individual optical conduits 1706A-D, each of which may include individual lenses and optical fibers. Also, certain embodiments may dispose electrical conduits 1712 to one or more sides of the optical conduits 1706A-D, as shown in the upper left portion of FIG. 17.

FIG. 18A shows a front cutaway view of the receptacle 1802 while FIG. 18B shows a side cutaway view of the receptacle 1802. FIGS. 18A-B also shows mechanical dimensional specifications for the receptacle 1802. The USB receptacle shown in FIGS. 18A-B may be a USB Type C receptacle. As shown in FIGS. 18A and 18B, the receptacle 1802 includes width and height specifications 1850A and 1850B, respectively that include tolerance values that determine a maximum and minimum dimensional specification for the width and height of the receptacle 1802.

Referring to FIGS. 15A, 15B, 18A and 18B, the plug 1504 is configured to be inserted into the receptacle 1802. The plug 1504 can be a minimum height of 2.37 millimeters while the opening of the receptacle 1802 can be a maximum height of 2.6 millimeters. The plug 1504 can be a minimum width of 8.22 millimeters while the opening of the receptacle 1802 can be a maximum width of 8.4 millimeters. As such, the maximum misalignment between the plug 1504 and the receptacle 1802 is 0.23 millimeters in height and 0.18 millimeters in width. Additionally, as shown in FIGS. 15A, 15B, 18A, and 18B, the optical conduits are disposed within 1.75 mm from a center of the plug and/or receptacle.

The receptacle 1802 also includes optical conduit 1806. The optical conduit 1806 can be configured to receive an optical signal in a forward portion of the receptacle 1802 and run toward a rear portion of the receptacle 1802. The optical conduit 1806 may be placed so that the form factor of the receptacle 1802 is not substantially disturbed and so the receptacle 1802 can be mated with a corresponding plug that does not include optical conduits.

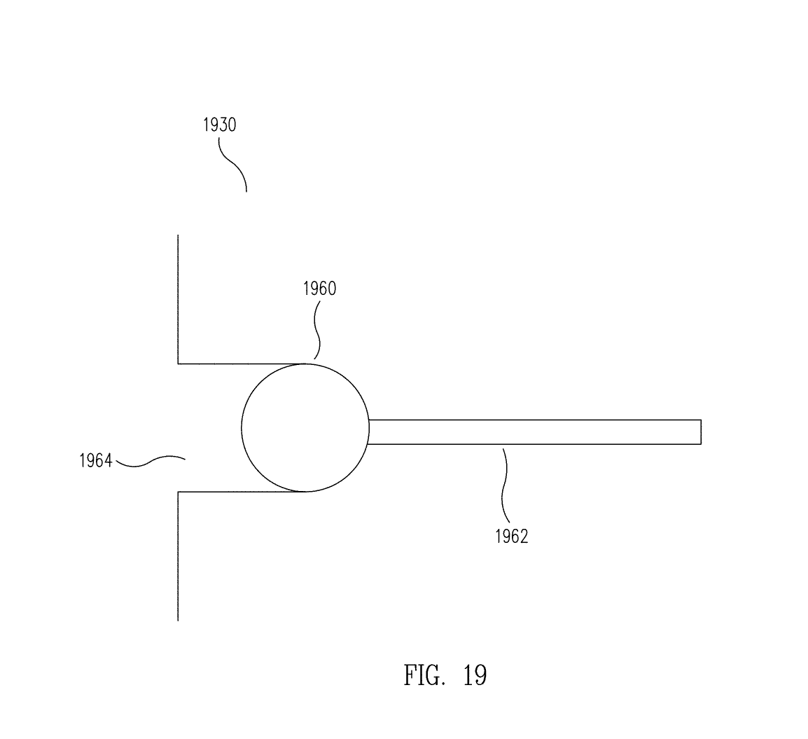

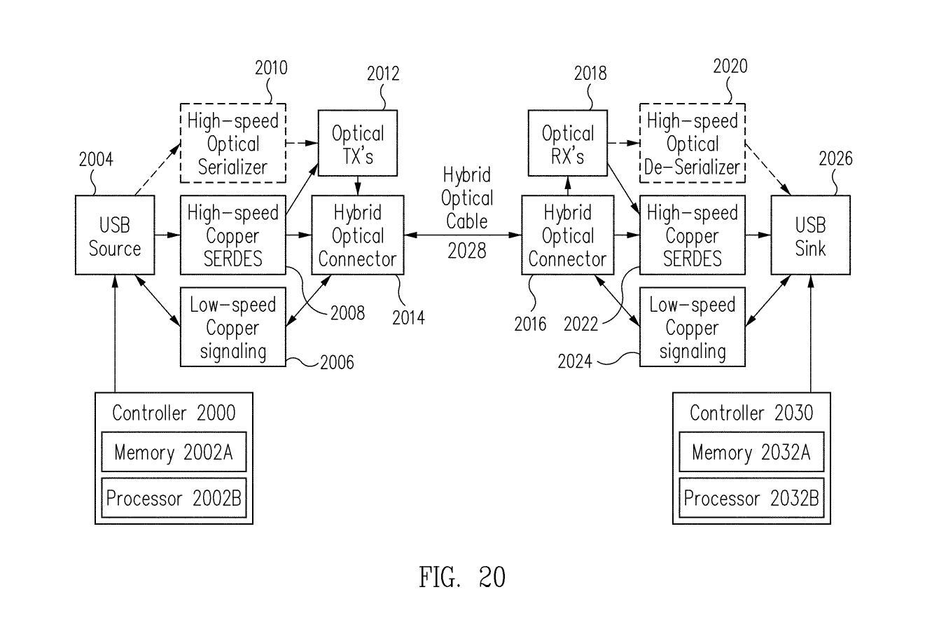

Referring now to FIG. 19, an optical conduit 1930 is shown. The optical conduit 1930 is disposed within a cavity 1964 of a plug and/or receptacle and includes lens 1960 and a fiber optic cable 1962 optically coupled to the lens 1960. As shown in FIG. 19, cavity 1964 includes an opening that allows an optical beam to be emitted and/or received by the optical conduit 1930.

The lens 1960 may be a ball lens. The ball lens configuration of the lens 1960 allows for an optical beam to be emitted and/or received by through a free space gap. The lens 1960 can collimate optical signals from the fiber optic cable 1962 and/or receive collimated optical signals and concentrate them into the fiber optic cable 1962.

The fiber optic cable 1962 is optically coupled to the lens 1960 so that it can communicate optical signals with the lens 1960 (e.g., provide and/or receive such optical signals). In certain embodiments, the fiber optic cable 1962 may be connected to the lens 1960, but other embodiments may, for example, include an air gap between the lens 1960 and the fiber optic cable 1962. In certain embodiments, the lens 1960 and the fiber optic cable 1962 can constitute an optical conduit. Such an optical conduit may be a ferrule-less optical conduit.

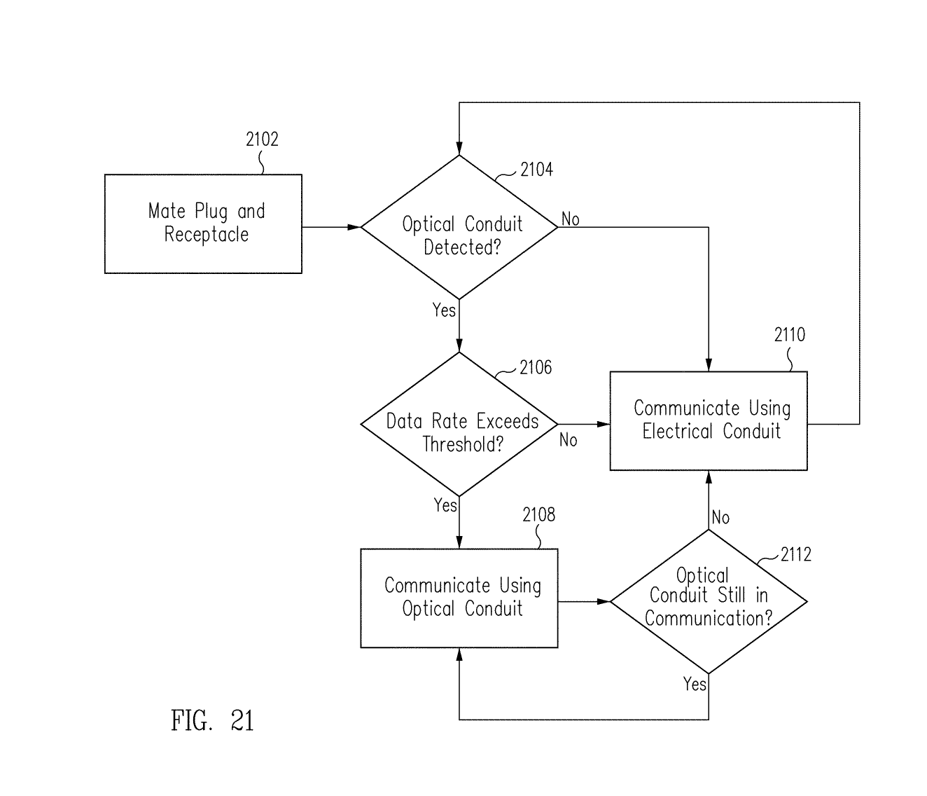

Referring to FIGS. 20 and 21, a method of operation using the hybrid electrical-optical interface is described. FIG. 20 illustrates a block diagram of a hybrid electrical-optical interface. Operation of such an interface is detailed in the flowchart of FIG. 21.

FIG. 20 illustrates a hybrid electrical-optical USB interface. The interface includes a controller 2000 with a memory 2002A and a processor 2002B. In certain embodiments, the controller 2000 may be a part of the USB source 2004 and/or may be communicatively connected to the USB source 2004 (e.g., through one or more signal connections) to control at least some of the operation of the USB source 2004. The USB source 2004 may be configured to provide one or more USB signals. Such signals may be electrical and/or optical. The controller 2000 and/or the USB source 2004 may be configured to determine whether to provide such signals electrically and/or optically pursuant to the techniques described herein. In certain embodiments, the USB sink 2026 also includes and/or is coupled to a controller 2030 with a memory 2032A and a processor 2032B. For the purposes of this disclosure, techniques and processes described herein as performed by the controller 2000 may also be performed, alternatively or additionally, by the controller 2030.

The USB source 2004 can provide such signals via a low-speed copper signaling 2006, high-speed copper SERDES 2008, and/or optical Tx 2012. In certain embodiments, if the USB source 2004 is providing optical signals via the optical Tx 2012, a high-speed optical serializer 2010 may also be included to serialize signals from the USB source 2004 into optical signals. Electrical signals from the low-speed copper signaling 2006 and/or high-speed copper SERDES 2008 and/or optical signals from the optical Tx 2012 are communicated to the hybrid optical connector 2014. The receptacle and/or plug described herein may include one or more of the hybrid optical connector 2014, low-speed copper signaling 2006, high-speed copper SERDES 2008, optical Tx 2012, and/or high-speed optical serializer 2010. Such signals are then communicated over the hybrid optical cable 2028 to the hybrid optical connector 2016.

After receiving the electrical and/or optical signals by the hybrid optical connector 2016, such signals may be passed to the high-speed copper SERDES 2022 and/or low-speed copper signaling 2006, if electrical signals, or optical Rx 2018, if optical signals. Certain embodiments may also include a high-speed optical de-serializer 2020 to de-serialize optical signals. One or more of the hybrid optical connector 2016, low-speed copper signaling 2024, high-speed copper SERDES 2022, optical Rx 2018, and/or high-speed optical de-serializer 2020 can be included in a plug and/or receptacle described herein. Signals from such can then be provided to the USB sink 2026. As such, FIG. 20 illustrates a hybrid electrical-optical interface that includes a plug and a receptacle. Both the plug and the receptacle can include optical conduits as well as mating features to allow the plug and receptacle to be mated.

Referring to FIG. 21, the plug and receptacle are mated in block 2102. The plug and receptacle, when mated, can include an amount of misalignment up to a maximum amount of misalignment allowed. The misalignment can be misalignment in the height and/or width direction and/or a combination of both (e.g., also including an angular misalignment portion). When mated, the optical Tx and Rx shown in FIG. 20, which may be optical conduits, may communicate optically through a free space gap.

After the plug and receptacle are mated in block 2102, the controller may detect whether optical conduits are present on both the plug and/or the receptacle in block 2104. Such a detection may be performed by, for example, communicating one or more test optical signals. If the controller receives an optical signal reply, the controller 2000 may determine that optical conduits (e.g., optical Tx and Rx 2012 and 2018) are present and proceed to block 2106. Otherwise, the controller 2000 may determine that optical conduits are not present and proceed to block 2110. Other embodiments may determine the presence of optical conduits through other techniques, such as through mechanical techniques (e.g., triggering components and/or sensors with the optical conduit) and/or through other communications techniques.

If the optical conduits are detected, the bandwidth (e.g., data rate) requirements are determined in block 2106 by the controller 2000. In a certain embodiment, the controller 2000 may determine the amount of data rate required to transmit via the electrical and optical conduits. If such a data rate is lower than a threshold data rate (e.g., the amount and/or speed of data to be transmitted is higher the bandwidth and/or speed of the electrical conduits), then optical signals are provided through the optical conduits. Other embodiments may, additionally or alternatively, determine if bandwidth is available for transmission via the electrical conduits and/or optical conduits. If the optical conduits include available bandwidth, then data may be transmitted via the optical conduits. If such conditions for using the optical conduits are satisfied, the technique may proceed to block 2108. If such conditions are not satisfied, the technique may proceed to block 2110.

In block 2108, optical signals may communicate via the optical Tx/Rx 2012/2018. The optical Tx/Rx 2012/2018 may communicate optically through a free space gap as described herein. During communication, block 2112 may be performed and whether the optical conduits are still in communication may be determined. If the optical conduits are determined to still be in communication, communications can continue to be performed via the optical Tx/Rx 2012/2018 in block 2108. If the optical conduits are determined to have lost connection, the technique may proceed to block 2110 and communicate via the electrical conduits.

In block 2110, communications can be performed using the electrical conduits (e.g., via the high-speed copper 2008/2022 and/or the low-speed copper 2006/2024). In certain embodiments, the techniques described may communicate with either the optical Tx/Rx 2012/2018 and/or the high-speed copper 2008/2022. Such embodiments may communicate separate signals through the low-speed copper 2006/2024, but may use the optical Tx/Rx 2012/2018 to complement and/or supplement signals communicated through the high-speed copper 2008/2022 as such high speed connections may benefit most from the increased speed of the optical Tx/Rx 2012/2018. The connections described herein (e.g., via the optical Tx/Rx, high-speed copper, and/or low-speed copper) may communicate signals from the USB source 2004 to the USB sink 2026. In certain embodiments, the controller 2000, when communicating with the electrical conduits in block 2110, may periodically proceed to block 2104 to see if communications may be switched to optical signals.

As such, an electronic device may utilize the optical communications capability of the hybrid electrical-optical interface if available, while using electrical communications if optical communications are unavailable. Thus, backwards compatibility is retained.

It is appreciated that the technique described in FIG. 21 is exemplary. Other techniques may be performed in an order different from that described in FIG. 21 (e.g., block 2112, if determined to still be in optical communication, and first return to block 2106), and/or may be performed with different steps.

The foregoing disclosure is not intended to limit the present invention to the precise forms or particular fields of use disclosed. As such, it is contemplated that various alternate embodiments and/or modifications to the present disclosure, whether explicitly described or implied herein, are possible in light of the disclosure. For example, embodiments with one or two optical connections are described, but a person skilled in the art will understand that the present disclosure may cover any number of optical connections that are physically supportable by the host device. Having thus described embodiments of the present disclosure, persons of ordinary skill in the art will recognize advantages over conventional approaches and that changes may be made in form and detail without departing from the scope of the present disclosure. Thus, the present disclosure is limited only by the claims.

1-20. (canceled)

21. A receptacle comprising:
a connector body configured to mate with a plug in accordance with a predetermined mechanical misalignment tolerance;
a tongue disposed within a central portion of the connector body;
a plurality of electrical conduits configured to pass electrical signals, wherein at least one electrical conduit is disposed on a top surface of the tongue and at least one electrical conduit is disposed on a bottom surface of the tongue; and
an optical conduit disposed within the tongue and configured to pass optical signals while the connector body is mated with the plug.

22. The receptacle of claim 21, wherein the optical signal is configured to pass through a free space gap formed while the connector body is mated with the plug, and wherein the optical conduit is configured to maintain communication of the optical signals through the free space gap while the connector body and the plug are within the misalignment tolerance.

23. The receptacle of claim 22, wherein the optical conduit comprises at least one lens and one fiber optic cable connected to the lens, and wherein the lens is configured to project at least one of the optical signals through the free space gap with a substantially Gaussian power density distribution exceeding a threshold density to maintain the communication during the misalignment.

24. The receptacle of claim 22, wherein the optical conduit is configured to pass at least one of the optical signals along a connector optical beam path substantially aligned with a plug optical beam path while the connector body is mated with the plug.

25. The receptacle of claim 22, wherein the misalignment tolerance is at least 0.23 millimeters in a height or width direction, and wherein the optical conduit is disposed within 1.75 mm from a center of the connector body.

26. The receptacle of claim 21, further comprising a controller configured to:
determine a data rate associated with data to be passed by the receptacle; and
selectively provide the data through the electrical signals or the optical signals based on the determined data rate.

27. The receptacle of claim 21, wherein the connector body comprises a perimeter wall separate from the tongue.

28. The receptacle of claim 27, wherein the plug is received within the perimeter wall.

29. A plug comprising:
a connector body configured to mate with a receptacle in accordance with a predetermined mechanical misalignment tolerance;
a plurality of electrical conduits disposed on inner surfaces of the connector body and configured to pass electrical signals;
a cavity disposed within a central portion of the connector body and configured to receive a tongue of a receptacle; and
an optical conduit disposed proximate the cavity configured to pass optical signals while the connector body is mated with the receptacle.

30. The plug of claim 29, wherein the optical signal is configured to pass through a free space gap formed while the connector body is mated with the receptacle, wherein the optical conduit is configured to pass at least one of the optical signals along a connector optical beam path substantially aligned with a receptacle optical beam path while the connector body is mated with the receptacle, and wherein the optical conduit is configured to maintain communication of the optical signals through the free space gap while the connector body and the receptacle are within the misalignment tolerance.

31. The plug of claim 30, wherein the optical conduit comprises at least one lens and one fiber optic cable connected to the lens, wherein the lens is configured to project at least one of the optical signals through the free space gap with a substantially Gaussian power density distribution exceeding a threshold density to maintain the communication during the misalignment.

32. The plug of claim 30, wherein the misalignment is at least 0.23 millimeters in a height or width direction.

33. The plug of claim 29, further comprising a controller configured to:
determine a data rate associated with data to be passed by the plug; and
selectively provide the data through the electrical signals or the optical signals based on the determined data rate.

34. The plug of claim 29, wherein the connector body comprises a perimeter wall configured to be disposed within at least a portion of the receptacle when the connector body is mated with the receptacle.

35. The plug of claim 34, wherein the perimeter wall is configured to be disposed within at least a portion of the receptacle.

36. A method comprising:
mating a plug to a connector body of a receptacle;
passing electrical signals through at least one of a plurality of electrical conduits disposed within the connector body, wherein at least one electrical conduit is disposed on a top surface of a tongue and at least one electrical conduit is disposed on a bottom surface of the tongue, and wherein the tongue is disposed within a central portion of the connector body; and
passing optical signals through an optical conduit disposed within the tongue while the connector body is mated with the plug.

37. The method of claim 36, wherein the connector body is mated to the plug in accordance with a predetermined mechanical misalignment tolerance, and wherein the optical signal is passed through a free space gap formed when the connector body is mated with the plug, and wherein the method further comprises:
maintaining communication of the optical signals through the free space gap while the connector body and the plug are within the misalignment tolerance.

38. The method of claim 37, wherein the optical conduit comprises a lens and a fiber optic cable connected to the lens, and wherein the method further comprises:
projecting, by the lens, at least one of the optical signals through the free space gap with a substantially Gaussian power density distribution exceeding a threshold density to maintain the communication during the misalignment.

39. The method of claim 37, further comprising:
determining a data rate to be passed; and
selectively providing the data through the electrical signals or the optical signals based on the determined data rate.

40. The method of claim 36, wherein the mating the plug to the connector body comprises disposing the plug within a perimeter wall of the connector body.
